(19) United States
(12) Patent Application Publication
(10) Pub. No.: US 2015/0348186 A1
(43) Pub. Date: Dec. 3, 2015

(54) SYSTEM AND METHOD FOR DYNAMIC CUSTOMER ACQUISITION PROBABILITY AND RISK-ADJUSTED RETURN-ON-EQUITY ANALYSIS

(71) Applicant: C1 Bank, St. Petersburg, FL (US)

(72) Inventors: Nikolai Samteladze, St. Petersburg, FL (US); Trevor Burgess, St. Petersburg, FL (US); Marcio deOliveira, Sarasota, FL (US)

(73) Assignee: C1 Bank, St. Petersburg, FL (US)

(21) Appl. No.: 14/287,459

(22) Filed: May 27, 2014

(51) Int. Cl. G06Q 40/02

(52) U.S. Cl. CPC G06Q 40/025

(57) ABSTRACT

Disclosed is a method of processing a user's loan request to a bank and making recommendations to the user and the bank. The invention includes using a computer code that evaluates user submitted loan data, public bank data, and private bank data to calculate a bank's risk-adjusted return-on-equity and customer acquisition probability on a given loan. The bank's private data may include bank profile settings and bank historical data. The bank's public data may include UBPR and bank call reports. Also, the method may be utilized to analyze the bank's performance over time.

### TECHNICAL FIELD AND BACKGROUND

This application relates to the field of loans and loan evaluations and, more particularly. to systems and methods for assessing customer acquisition probability and loan profitability.

Customers typically contact lending institutions which must decide whether or not to offer a loan to the customer, and if a loan is offered, on what terms. Likewise, the customer, if offered a loan, must decide whether or not to accept the terms. The systems and methods disclosed herein provide a loan evaluator which permits both the lending institution and its customer to receive loan availability and loan terms in real time. It also affords the customer and lending institution the ability to alter loan attributes and immediately adjust the recommendations until terms satisfactory to both parties are reached in real time.

The extension of credit from a lender to a borrower in the form of a loan is an important element in modern economics which allows individuals and entities to leverage assets and credit history in order broaden the scope of available resources. Likewise, it allows lending institutions to invest in and obtain a rate of return via the extension of credit. In such a loan arrangement, the lender and the borrower each assess their respective levels of trust between each other in view of desired outcomes. The trust and the availability of a desired transaction may be established by a number of factors including present assets, past histories, industry standards, economic climate, and insurance backing of each of the parties.

The assessment allows the lender to provide resources, such as capital, to the borrower such that the borrower does not immediately reimburse the lender (thereby incurring a debt), but instead arranges either to repay or return those resources (or other materials of equal or similar value) at a later date. Typically, the repayment or return is coupled with some bargained-for resource, such as capital, which is paid or returned to the lending institution by the borrower as consideration for extending the credit to the borrower. Though the particular resources obtained by the lending institution may vary, it is often in the form of an interest rate charged against the amount of capital being borrowed. This consideration received by the lending intuition may include a flat fee instead of, or in addition to, the interest rate. Further, the consideration received by the lending institution may be provided by the borrower at initiation of the loan, during the term of the outstanding loan, and/or upon full repayment of the principal of the loan.

Loans provided from the extension of credit may cover a variety of transactions including: consumer lending, general personal finance lending, credit card lending, education lending, internet based lending, automobile lending, mortgage lending, equipment lending, small business lending, micro-loan lending, and other business finance lending.

Lending institutions are highly regulated and, in the United States, the Federal Financial Institutions Examination Council (hereinafter the “FFIEC”) is a formal interagency body empowered to prescribe uniform principles, standards, and report forms for the federal examination of financial institutions by the Board of Governors of the Federal Reserve System, the Federal Deposit insurance Corporation (hereinafter the “FDIC”), the National Credit Union Administration (hereinafter the “NCUA”), the Office of the Comptroller of the Currency, and the Consumer Financial Protection Bureau and to make recommendations to promote uniformity in the supervision of financial institutions. As part of this regulation and reporting, the FFIEC issues a Uniform Bank Performance Report (hereinafter the “UBPR”) for various lending institutions. The UBPR is a tool created for lending institution supervisory, examination, and management purposes. Essentially, the UBPR shows the impact of management decisions and economic conditions on a bank's performance and balance-sheet composition. The performance and composition data contained in the report can be used as an aid in evaluating the adequacy of earnings, liquidity, capital, asset and liability management, and growth management.

Like the UBPR, lending institutions may be required to quarterly submit a consolidated report of condition and income, generally referred to as a “call report.” The content of call report requirements may vary depending on the size and type of lending institution but generally include income statements, changes in bank equity capital, charge-offs and recoveries on loans and leases, balance sheets, securities, loans and leases, trading assets and liabilities, deposit liabilities, and other assets and liabilities.

Lending institutions may use the UBPR and/or call reports to further their understanding of the lending institution's financial condition. There is a need in the art that such reports be more effectively utilized in the lending decision process and there is a need in the art for improved utilization.

Typically, a potential customer or borrower must apply for a loan from a lending institution such as a bank before credit will be extended. The borrower may utilize an agent, such as a bank or lending institution associate, to apply for a loan. The borrower may ask for a particular sum of money from the lending institution to be repaid over a period of time and with paying a fee, interest rate, or other consideration to the lending institution. In so doing, the customer must provide the lending institution with data sufficient to allow the lending institution to evaluate the borrower's ability or likely ability to timely repay the loan. The loans may or may not be secured by various borrower assets. Likewise, the data supplied by the borrower allows the lending institution to craft terms applicable to the borrower's ability to repay the loan in view of the lending institution's desired rate of return.

In addition to the data provided by the borrower, the bank must evaluate its anticipated rate of return on the capital or other resource extended to the borrower or potential borrower. It is desirable that such a rate of return may be considered in view of the risk the lending institution takes in offering the loan. The lending institution may subscribe to various publications, and loan officers at the lending institutions may personally review various factors in an attempt to determine the lending institution's potential rate of return, accounting for risk. Difficult to timely assess under the current state of the art, this term has been identified as the risk adjusted return on equity (hereinafter the “RAROE”).

This process of determining the lending institution's relative exposure and potential gain via the RAROE is notoriously difficult, time-consuming, and speculative due to inefficiencies in the determination process. Indeed, it can be cost and time prohibitive to review all factors necessary to calculate an accurate and reliable RAROE under the current state of the art. It can be especially cost and time prohibitive to carefully consider the information in the UBPR and/or call reports when assessing and analyzing every loan request. Typically, a potential customer may apply to a lending institution for a loan, outlining its desired terms, and submit all requisite data to the lending institution. The lending institution must then process and personally analyze the data, and then compare the potential borrower's terms and potential risk with the gain the lending institution desires from the transaction. This process requires individuals at the lending institution to personally review, calculate, and evaluate the risk and potential return for the lending institution. Only upon completion of this process can the lending institution make a competent decision whether or not to extend a loan on the borrower's terms—at which time days, if not weeks, have passed since the potential borrower submitted its application and data.

It is common in the art for borrowers and potential borrowers to require their loan sooner rather than later and to make competing offers to multiple lending institutions. If a complex review of RAROE is desired by a particular lending institution, even more time and cost may be incurred thus diminishing the chance that a potential borrower may ultimately finance with the lending institution as the borrower may have, by the time a detailed RAROE is completed, chosen to borrow from a different institution.

After this process just described is complete, which takes significant time, the lending institution may or may not extend a loan offer. If it declines to extend an offer, the customer must then re-apply with new loan terms for the lending institution to consider, if at all. Similarly, even if the lending institution extends an offer based on the customer's terms, the lending institution may not be maximizing its RAROE based on the offered terms because of the many inefficiencies in the process, including time delays. Likewise, the customer may not be receiving the best available loan from the lending application, but, instead, merely the one associated with the customer's loan request.

Thus, there is a need in the art for a system and method of rapidly analyzing customer data, lending institution data, market data, and other relevant data in order to rapidly provide the lending institution with reliable and detailed RAROE recommendations and to provide the customer with a rapid response on a loan request. There is a long-felt need that this analysis be performed in real-time and that the results and recommendations be provided instantaneously or nearly so, so that both the borrower and the lending institution may make informed decisions in a short amount of time. Additionally, there is a need in the art for a method and system of offering or suggesting different terms to both the borrower and the lending institution, based on the borrower's data in an application and the lending intuition's desired risk adjusted rate of return. There is a need in the art that the suggested different terms offer an improved RAROE to the lending institution and also terms agreeable or even more agreeable, relative to the initial application, to the borrower.

### SUMMARY

Therefore, it is an object of the invention to provide a method and system of rapidly and dynamically assessing and analyzing customer data, lending institution data (such as in call reports and UBPR reports), market data, and other relevant data in order to rapidly provide the lending institution with reliable and detailed RAROE recommendations and to provide the customer and user with a rapid response on a loan request. It is a further object of the present invention that the assessments and analysis be performed in real-time and that the results and recommendations be provided instantaneously or nearly so, so that both the borrower and the lending institution may make informed decisions in a short amount of time. It is a further object of the present invention that the method and system offer or suggest different terms to both the user and the lending institution, based on loan data in a loan request and the lending intuition's desired risk adjusted rate of return. It is a further object of the present invention that the suggested different terms offer an improved RAROE to the lending institution and also terms agreeable or even more agreeable, relative to the initial application, to the borrower.

These and other objects and advantages of the invention are achieved by providing a system and method of dynamically and rapidly assessing customer acquisition probability and risk-adjusted return-on-equity concerning one or more potential loans. The system includes a computer implemented method of evaluating a user's loan request to a bank and of making recommendations. The method may include the steps of loading a bank computing device with loan evaluation computer code. The loan evaluation computer code may include an interface for accepting a loan request having loan data. The computer code may further include an interface for accepting public bank data, an interface for accepting private bank data, a recommendation engine for making recommendations to the bank and the user, and a loan evaluation model.

Another step of the method may include using the bank computing device to receive the loan request having loan data, the private bank data, and the public bank data. Another step of the method may include evaluating the loan request in view of the loan data, public bank data, and the private bank data. Another step of the method may include making recommendations to the user based on the loan data, the public bank data, and the private bank data. Another step of the method may include making recommendations to the bank based on the loan data, the public bank data, and the private bank data.

According to another embodiment of the invention, the public bank data may include bank performance data and market data. According to another embodiment of the invention, the public bank data may include UBPR and/or call reports. According to another embodiment of the invention, the private bank data may include bank profile settings. According to another embodiment of the invention, another step may include the step of configuring the bank profile settings by the bank by selecting one or more settings. Such settings may include penalizing a CRE loan, penalizing a high-risk loan, setting a minimum rate, setting a maximum loan life, and utilizing a combined funds model. According to another embodiment of the invention, the private bank data may include the bank's historical loan data.

According to another embodiment of the invention, the recommendations made to the bank may include: risk-adjusted return-on-equity suggestions, bank profile settings changes, and/or user efficiency suggestions.

According to another embodiment of the invention, the data input by the user may include a loan amount, a loan rate, a loan fee, a maturity period, an amortization period, an interest only period, a loan purpose code, an amount of noninterest bearing deposits, and a loan risk code.

According to another embodiment of the invention, the public and private bank data may be updated daily, weekly, monthly, or quarterly.

According to another embodiment of the invention, the method and system may function out-of-the box without requiring bank historical data or applying settings to the bank profile settings which may come preloaded with standard settings.

According to another embodiment of the invention, the method and system may further include an additional step of making additional recommendations to the bank by the bank computing device based the loan data, the public bank data, and the private bank data. These additional recommendations may include customer acquisition probability.

According to another embodiment of the invention, the loan evaluation computer code may include a bank dashboard, and an additional step of the method may include reporting to the bank via the bank dashboard aggregate customer acquisition statistics and aggregate risk-adjusted return-on-equity.

### BRIEF DESCRIPTION OF THE DRAWINGS

The present invention is best understood when the following detailed description of the invention is read with reference to the accompanying drawing, in which:

FIG. 1 is an exemplary hardware configuration for a system according to one embodiment of the invention;

FIG. 2 is a flow chart demonstrating the method and system according to one embodiment of the invention;

FIG. 3 is an exemplary display screen for inputting loan data;

FIG. 4 is an exemplary display screen for inputting loan data that illustrates selection of a purpose for the loan;

FIG. 5 is an exemplary display screen for inputting loan data that illustrates selection of a purpose for the loan;

FIG. 6 is an exemplary display screen utilized for inputting loan data that illustrates partial adjustment of attributes via a sliding scale;

FIG. 7 is an exemplary display screen utilized for inputting loan data that illustrates partial adjustment of attributes via a sliding scale;

FIG. 8 is an exemplary display screen utilized for inputting loan data that illustrates an output of the RAROE calculation and user recommendations;

FIG. 9 is an exemplary display screen utilized for inputting loan data that illustrates an output of the RAROE calculation; and

FIG. 10 is an exemplary display screen utilized by the bank for reviewing statistics and recommendations generated by the method and system of the current invention; and

FIG. 11 is an exemplary display screen that illustrates an output of recommendations.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention.

The term financial service provider (“FSP”) generally describes a person or entity providing lending and other financial services and includes banks, credit unions, thrifts, alternative financial service providers, or other types of financial institutions. The term FSP is used interchangeably with the terms provider, bank, financial institution, or lending institution. The term associate is used interchangeably with the term representative and generally describes an individual employed by or associated with a provider and who provides service to customers and is involved in the loan application process. The term user describes an individual who utilizes the systems and methods of the present invention and can include financial service provider associates or customers. The term customer generally describes an entity or individual utilizing services offered by the financial service provider, and the term may be used interchangeably with the terms consumer, client, borrower, or applicant.

Disclosed herein is a system and method of dynamically and rapidly assessing customer acquisition probability and risk-adjusted return-on-equity concerning one or more potential loans. The method and system allow a bank to assess and analyze customer data, bank data (such as in call reports and UBPR reports), market data, and other relevant data in order to rapidly provide the bank with reliable and detailed risk-adjusted return-on-equity (“RAROE”) recommendations and to provide the user with a rapid response on a loan request or application. The method and system of the present invention allow the assessments and analysis to be performed in substantially real time and so that both the customer and the bank can make informed decisions in a short amount of time. The method and system of the present invention includes the capability of offering or suggesting alternate loan terms based on customer data and the bank's desired RAROE. The different terms offered or suggested by the method and system should include an improved RAROE to the bank and also terms agreeable or even more agreeable, relative to the initial application, to the borrower.

The system and method of the present invention utilizes input data specifying the initial loan request parameters. This input initiates the process of analyzing bank performance data accessible from pubic data sources (such as bank call reports and UBPR) and bank profile settings specified by the bank, to calculate RAROE and customer acquisition probability using the loan evaluation model of the present invention. Further, the recommendation engine of the present invention uses market data and historical loan data in addition to bank performance data and bank profile settings to generate recommendations to both user and to the bank. These recommendations suggest how loan RAROE can be increased and how the customer acquisition process can be improved.

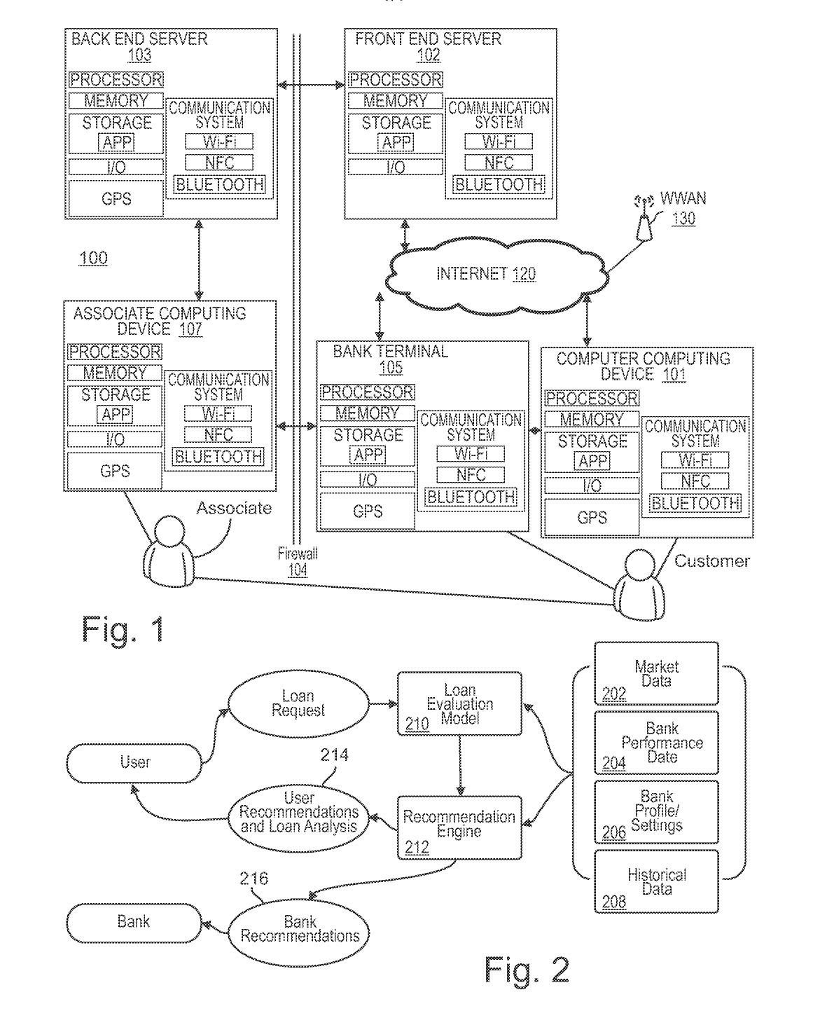

As shown in FIG. 1, a hardware configuration according to one embodiment of the invention generally includes a computing device (e.g., an Internet-enabled device) operated by a customer and a computer system associated with a bank 100. The bank's computer system 100 may include a front end server 102, a firewall 104, and back end server 103, and one or more computing devices 107 operated by bank associates. The system 100 shown in FIG. 1 is not intended to be limiting, and one of ordinary skill in the art will recognize that the method and system of the present invention may be implemented using other suitable hardware or software configurations. For example, the system 100 may utilize only a single server implemented by one or more computing devices or a single computing device may implement one or more of the front end server 102, back end server 103, firewall 104, and/or associate computing devices 107.

Further, a single computing device may implement more than one step of the methods described; a single step may be implemented by more than one computing device; or any other logical division of steps may be used. To illustrate, the associate computing device 107 can be used to initiate a loan request and display the outputs 214 & 216, as shown in FIG. 2, while the bank back end sever 103 gathers inputs 202, 204, 206, & 208 and implements the loan evaluation model 210 and recommendation engine 212. Alternatively, the associate computing device 107 can be used to initiate a loan request, display outputs 214 & 216, as well as implement the loan evaluation model 210 and recommendation engine 212.

Any suitable computing device can be used to implement the consumer computing device 101 or the components of the bank's computer system 100. The consumer computing device 101, the bank's servers 102-103, and the associate computing devices 107 may include a processor that communicates with a number of peripheral subsystems via a bus subsystem. These peripheral subsystems may include a storage subsystem, user-interface input devices, user-interface output devices, a communication system, and a network interface subsystem. By processing instructions stored on one or more storage devices, the processor may perform the steps of the present method. Any type of storage device may be used, including an optical storage device, a magnetic storage device, or a solid-state storage device.

Typically, the consumer computing device 101 accesses the bank's computer system 100 over the Internet 120 in the normal manner—e.g., through one or more remote connections, such as a Wireless Wide Area Network (“WWAN”) 130 based on 802.11 standards or a data connection provided through a cellular service provider. These remote connections are merely representative of a multitude of connections that can be made to the Internet 120 for accessing the provider's computer system 100.

As illustrated in FIG. 1, a customer has the option to initiate a loan request through a variety of channels. By way of example, a customer is able to initiate a loan request using a consumer computing device 101 to access the provider's computer system 100 through a provider website operated on the front end server 102. A customer can also initiate a loan request through a bank terminal 105 (e.g., automated teller machine) or the customer can engage a provider associate by telephone or in person at a provider retail location. In one embodiment, a provider associate utilizes a mobile computing device, such as a tablet computer, to gather information from the customer.

Regardless of how the customer initiates the loan request, the system prompts the customer or associate using a series of questions or data fields to enter some or all of the data required to initiate a loan request. The system includes one or more integrated software applications that provide a graphical user interface, permit communication between computing devices, and generally implement the steps of the methods disclosed herein. The user-interface screens include features for accepting inputs from users, such as text boxes, an adjustable sliding scale function, hyperlinks, pull-down menus, check boxes, radio buttons, and the like. The system utilizes a variety of public and private data sources. The recommendation engine 212 and loan evaluation model 210 rely on data received from several sources: loan data input by the user, market data 202, the bank's public performance data 204 (as contained in call reports and/or UBPR reports), the bank's profile settings 206, and the bank's historical data 208.

As can be seen in FIG. 2, the user inputs loan data in the form of a loan request or application. This loan request triggers a loan evaluation 210. The loan evaluation 210 meshes with the recommendation engine 212 of the current invention. In addition to the user inputs, both the loan evaluation model 210 and the recommendation engine 212 may utilize market data 202, bank performance data 204, bank profile settings 206, or historical loan data 208. Utilizing these data sets, the recommendation engine 212 provides user recommendations and loan analysis 214 regarding changes to the loan terms that can increase the RAROE as well as strengthen the customer relationship. The recommendation engine can also provide bank recommendations 216 designed to suggest ways that associates can adjust their behavior to increase efficiency and RAROE.

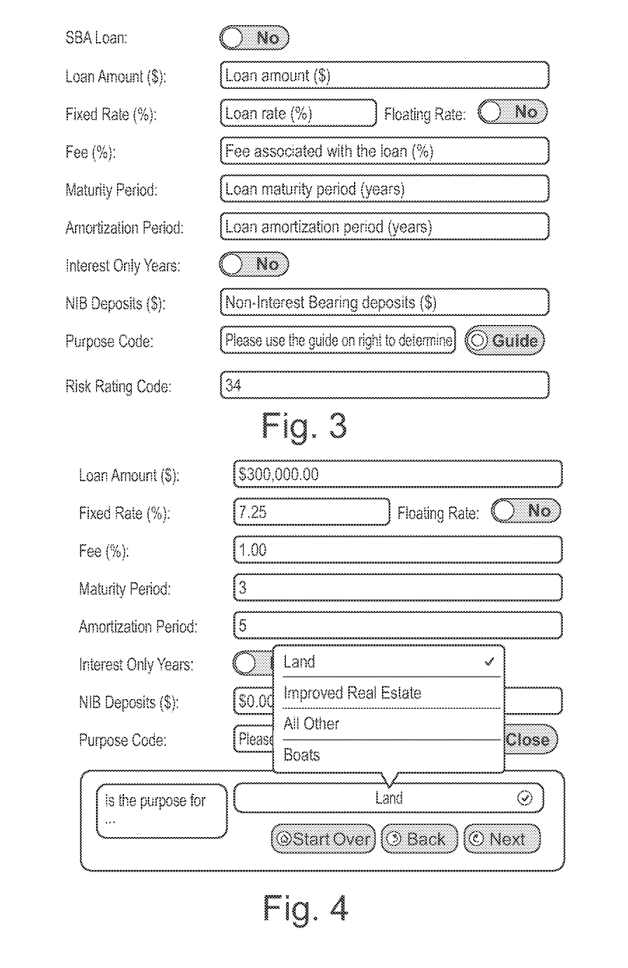

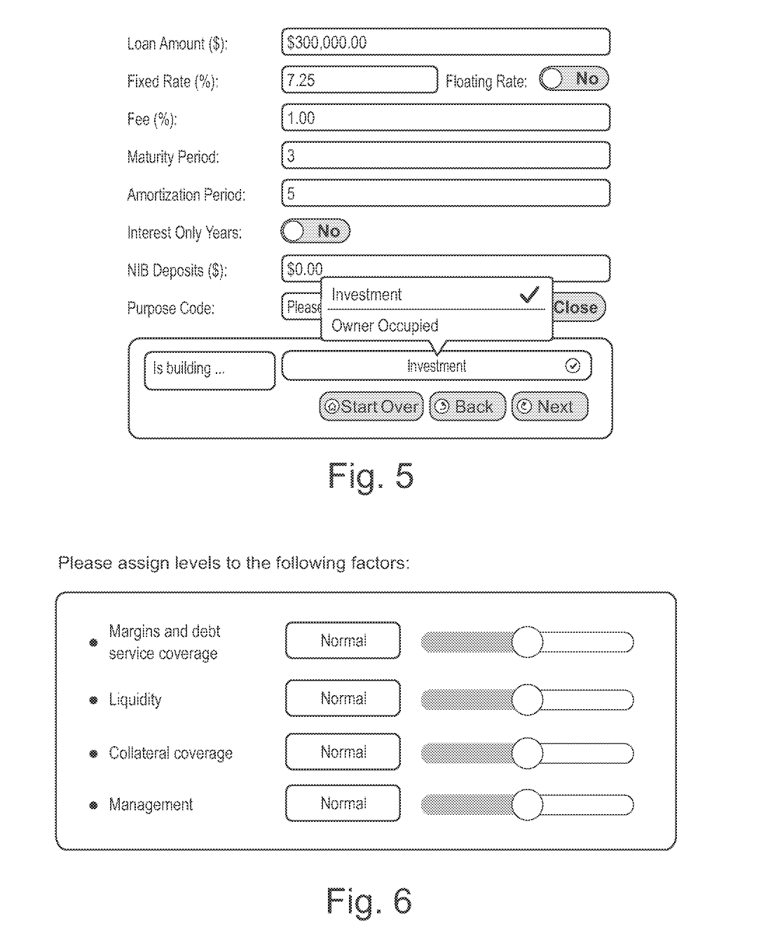

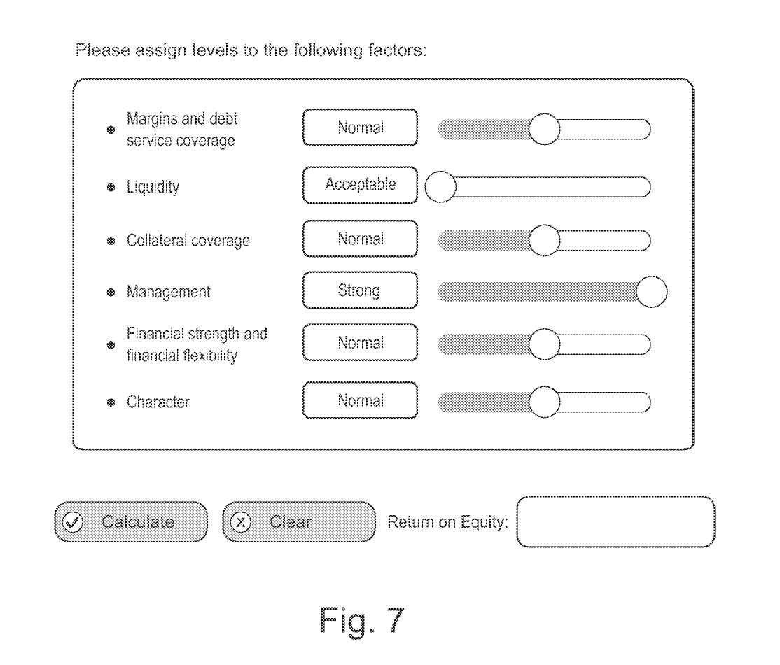

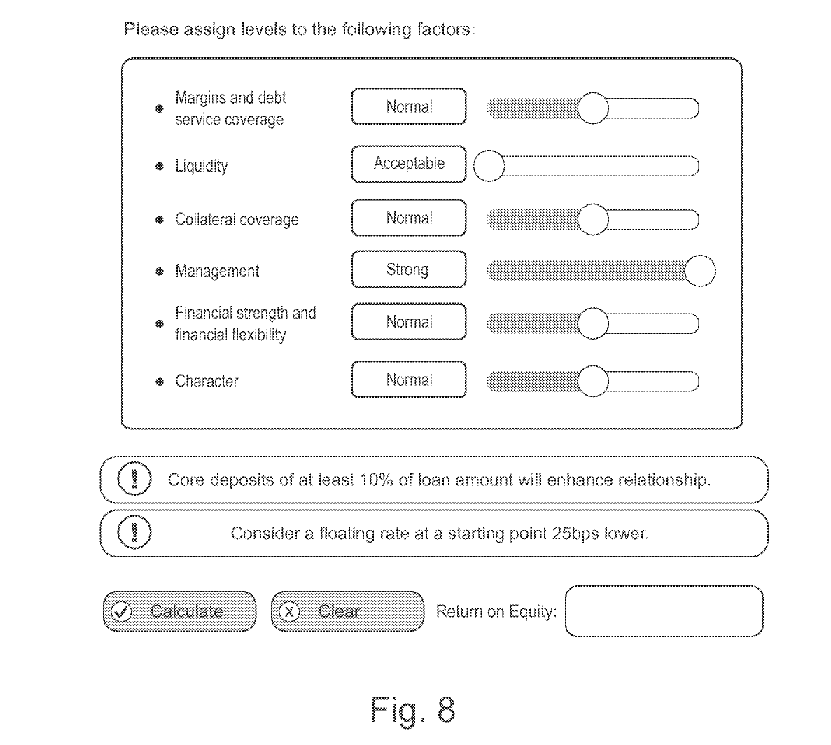

The loan data input when initiating a loan request may include: a desired loan amount, loan rate (fixed or floating as index plus spread) paid to the bank, fee paid to the bank, maturity period, amortization period, interest only period, loan purpose, noninterest bearing deposits (“NIB”), and loan risk. The loan purpose and loan risks may be included as a code derived via an algorithm based on user input. This data is included in the “Loan Request” of FIG. 2. See also FIGS. 3-5 for exemplary displays of user input. As shown in FIG. 3, the invention contemplates that the user will use the computer system to input the loan data. The user input loan data fields are initially substantially blank and unfilled. As shown in FIG. 4, the user has begun to fill the input loan data, and the system is determining the purpose code. As shown in FIG. 5, the user is determining the risk rating code. Both the purpose code determination of FIG. 4 and the risk rating code of FIG. 5 may ask the user a series of questions in order to determine the code. As shown in FIGS. 6-8, the user may also adjust factors relating to the particular borrower. These may be provided via a slidable scale displayed on a computer screen, which is set in the system by the user. Such factors may include: margins and debt service coverage, liquidity, collateral coverage, management, financial strength and financial flexibility, and character. FIG. 6 shows the sliding scales set to “normal.” FIGS. 7 and 8 show the scales which have been adjusted for a particular borrower which has “strong” management and “acceptable” liquidity with other factors as “normal.”

Referring to FIG. 2, the public data utilized by the present system and method include bank performance data 204 as contained in the call reports and/or UBPR reports and current market data 202. These public data sources are used to acquire information about the current bank performance and the current market state. Bank performance information gives insight to current loan portfolio and call list statistics. Current bank performance data 204 is used to determine the RAROE of new loans. The current market state data, including rates offered by competition, has a significant impact on the recommendations generated by the system. The current market data 202 may be provided by the bank or by one or more different commercial data suppliers.

In addition to the user input data and public data, as shown in FIG. 2, private data utilized by the invention may include historical loan data 208 and bank profile settings 206. Historical bank data 208 about previously booked loans is used to help generate loan recommendations. When a user evaluates a loan, data about similar loans previously booked by the institution is analyzed. This helps to determine the ranges in which terms can be adjusted to increase loan RAROE and quality. The historical bank data 208 is also used to give the user information as to what percentile the terms (rate, maturity, risk, etc.) are compared to other loans previously approved by the bank.

As the method and system of the current invention is utilized by a bank over a period of time, historical data 208 about evaluated loans is also stored. As shown in FIG. 10, this stored data is used to generate reports and provide recommendations 216 to the bank on how bank associates approach loan negotiations and what can be done to improve the process.

However, use of the bank's historical data 208 is not required. A version of the present invention that does not utilize the bank's historical data 208 is contemplated by the present invention and comprises an alternate embodiment (the “out-of-the-box” embodiment). This out-of-the-box embodiment of the system is fully functional out of the box and does not need integration with bank's internal data sources (historical data about booked loans) to evaluate potential loans and to provide recommendations. Instead, the out-of-the-box embodiment may utilize public and private data sets as disclosed except the bank historical data 208.

The bank profile settings 206 is another set of private data utilized by the present invention. Bank profile or bank settings 206 define what strategy the bank follows when giving loans to clients. Defining a profile allows the bank's management to configure the system's behavior and to enforce certain rules, including aggressiveness in seeking new loans and new clients. Like historical bank data 208, in an alternate out-of-the-box embodiment of the present invention, the bank profile settings 208 do not require manipulation in order for the system to generate recommendations, in such an alternate embodiment, the system generates a default bank profile 206 based on the bank's performance and current market data 204. This allows the system to generate bank specific results out of box.

The present invention contemplates a system wherein the bank profile settings 206 may be configured in many different ways. Without limiting and by way of example only, configurable settings may include: penalizing commercial real estate (“CRE”) loans, utilizing a combined funds model, penalizing high-risk loans, utilizing and setting a minimum rate, setting a maximum loan life. For instance, in penalizing CRE loans under the current system, the bank may use settings in the system to penalize CRE loans by requiring high equity rates. Under a combined funds model, the bank, using the system, is able to determine and set fractions of bank funds and borrowed funds used when financing a loan. In penalizing high-risk loans, the bank is able to use the system to set an upper bound which can be configured for high-risk loan RAROE. Likewise, the bank is able to use the system to set a minimum rate where evaluations of loans with less than the minimum rate will fail. The system of the present invention also contemplates that the bank settings may enable the bank to set a maximum loan life such that evaluations will fail if the loans have a life span greater than the maximum.

As shown in FIG. 2, the system utilizes these sets of data to evaluate the loan request, to generate recommendations to the user 214 (“user recommendations and loan analysis”), and to generate recommendations to the bank 216 (“bank recommendations”). Thus, the recommendation engine 212 performs a dual purpose: the recommendation engine 212 produces recommendations to the users evaluating loans and to the bank (the lending institution which may offer a loan). The system of the present invention suggests changes to the loan terms which will increase loan RAROE and strength of the relationship. To make a user recommendation 214, the system analyzes which loan terms can be changed to have the greatest impact on increasing loan RAROE. Loan terms are changed within ranges determined by analyzing terms of the similar loans that have previously been booked by the bank. Loans similarity is evaluated based on loan purpose and loan amount.

User recommendations 214 regarding RAROE can be better understood with reference to the following simplified example. A customer may initiate a loan request for a commercial loan of $100,000 at two percent interest with a period of five years and a two percent origination fee. Based on an analysis of bank historical data 208 and market data 202, the recommendation engine 212 may determine that other commercial loans of similar amount are typically originated at four percent interest and a four percent origination fee. In that case, the recommendation engine 212 may recommend that the interest rate be adjusted upward two percent but that the origination fee be maintained at two percent because adjusting the interest rate would have a larger effect on RAROE while still maintaining an interest rate and origination fee at amounts competitive with historical and market rates.

The system of the present invention also provides user recommendations 214 which improve the chances of a prospective client accepting the loan terms. These recommendations are based on analyzing loan terms to determine which terms can be changed in the customer's favor without sacrificing risk-adjusted return-on-equity for the bank. As an example, if the customer has very little deposits with the bank, the system might recommend that the customer increase noninterest bearing deposits with the bank to reduce the amount needed to fund a loan. This could permit the bank to make an adjustment to a lower interest rate without sacrificing RAROE.

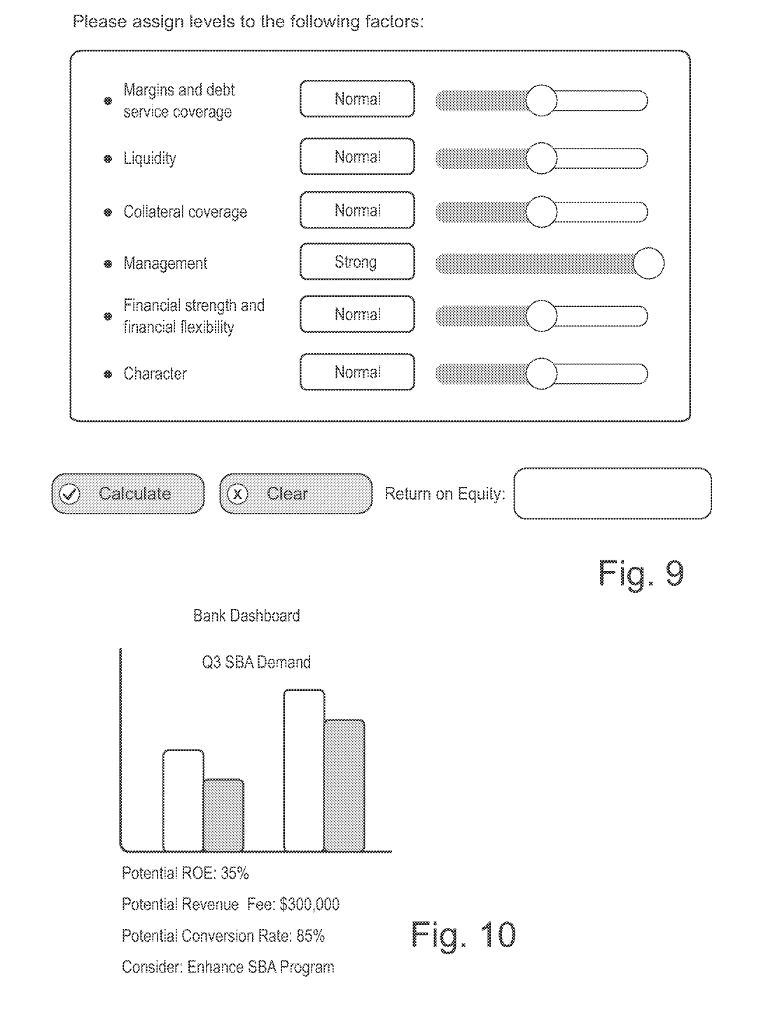

Additional examples of user recommendations 214 are shown in FIG. 8. By following recommendations produced by the recommendation engine 212, the method and system of the present invention provides that the terms of unsatisfactory loans can be reconfigured to produce a more satisfactory loan. As seen in the example of FIG. 8, a user has input that the “Liquidity” is merely “Acceptable” while “Management” is “Strong” and the other factors are “Normal.” In combination with other data (not shown) which has been passed as shown in FIG. 2, the recommendation engine 212 has produced the output recommendation: “Core deposits of at least 10% of loan amount will enhance relationship” and also “[c]onsider a floating rate at a starting points 25 pbs lower.” FIG. 8 shows this “return on equity” as yellow (i.e., normal). In contrast, by increasing liquidity as shown in FIG. 9 to “normal, the RAROE has been increased to green or “strong.”

Like the recommendations to the user 214, the recommendation engine 212 also generates recommendations 216 for the bank based on user behavior and data from various sources. These recommendations suggest ways that user behavior can be adjusted in order to increase efficiency and RAROE. The system also proposes changes to the bank profile 206 to ensure the configurations are aligned to current bank and market conditions.

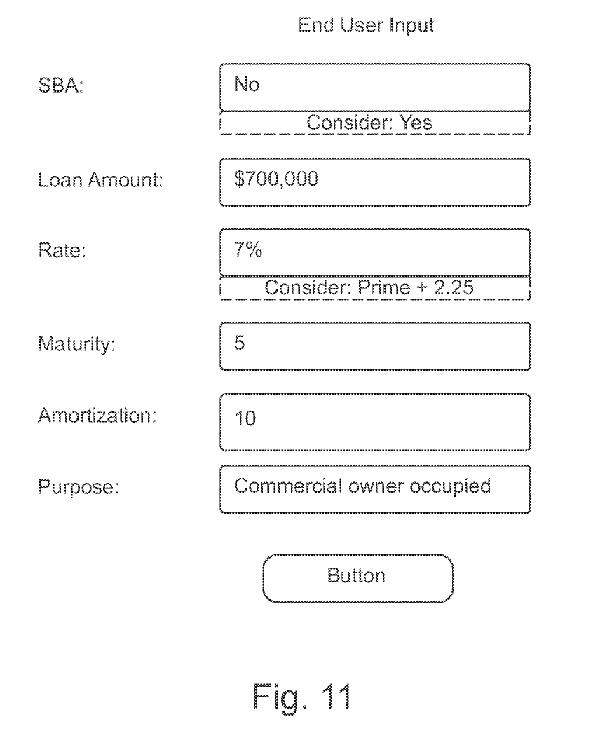

Examples of bank recommendations 216 are illustrated in FIGS. 10-11. Through the bank dashboard shown in FIG. 10, and bank recommendations 216, may review aggregated statistics, such as statistics for potential return on equity, revenues, conversion rates, and bank recommendations 216, like “Consider: Enhance SBA Program.” At the loan level, the system can also provide bank recommendations 216 to users, such as those shown in FIG. 11 where the system recommends that the user consider a Small Business Administration loan (“SBA Loan”) at a different interest rate of “Prime+2.25.”

In making recommendations to the bank and to the user, the recommendation engine 212 relies on the loan evaluation model 210 and the data sets as shown in FIG. 2. The bank's potential profit from a loan is based on the RAROE, which is calculated as follows:

$$RAROE = \frac{Average Margin}{Average Capital Used}$$

For each loan, this RAROE may be expressed as a number, or it may be expressed as a qualitative assessment, such as the color outputs shown in FIGS. 8 and 9—i.e., “Return on Equity: Normal” or “Return on Equity: Strong.”

Average margin and average capital used, as utilized in the RAROE calculation above are calculated as follows:

$$Average Margin = \frac{Total Margin}{Loan Life}$$

$$Average Capital Used = Average Outstandings \times Equity Rate$$

The loan life, utilized in the average margin calculation above is calculated as:

Loan Life=Maturity Period+Interest Only Period

The average outstanding, as utilized in the average capital used calculation above, is calculated as an average of monthly outstanding balances during loan life period:

$$Average Outstanding = \frac{{Σ}_{i = 1}^{N} Outstanding {Balance}_{i}}{N}$$

The monthly outstanding balance is determined based on calculated payments schedule, with an equal payment every month. If a loan has different equity rates during the loan life period (e.g., loan with construction period), then a weighted sum of average capital used value is used in calculations.

It is generally true that the average outstanding amount of funds is needed to fund a loan. However, NIB deposits that a client keeps in the bank decrease the required funding. Thus, funded amount is calculated as:

Funded Amount=Average Outstanding−NIB Deposits

In the case a customer brings more NIB deposits into the bank than the average outstanding expected value for this loan, funded amount will equal zero. This will result in zero cost associated with the loan for the bank.

In making recommendations 214 & 216, the system considers the bank's total margin. Total margin is the difference between loan revenue and loan cost. Loan revenue consists of interest received during loan life and a fee collected when the loan is booked. The cost associated with a loan consists of cost of funds, cost of reserves, and cost of risk adjustment. The present invention takes into account that the bank's total margin is calculated differently depending on the loan rate type.

One type of loan assessed in the loan evaluation model 210 and upon which recommendations are made in the recommendation engine 212 can be a fixed-rate loan. For fixed-rate loans, collected interest is calculated using an amortization schedule as a sum of interest occurred each month during loan life:

$$Total Interest = Rate \times {\sum }_{i = 1}^{N} Outstanding {Balance}_{i}$$

The fee is considered a one-time profit, collected when the loan is booked.

The cost of funds (“COF”) for loans with a fixed rate is determined based on a combined funds model. Funds are considered to come from two sources: (1) bank funds (deposits and bank capital): and (2) borrowed funds. The bank's cost of funds rate (“bank COF”) is considered to be constant through the loan life and is equal to the average cost of interest-bearing funds rate taken from UBPR report which is provided in the bank performance data 204. Borrowed cost of funds (“borrowed COF”) is determined using the federal home loan bank rate (“FHLB”) curve based on the loan life. For example, if the loan life is five years, a five-year federal home loan bank rate “FHLB rate” is taken. The bank's management can change the proportion between bank funds and borrowed funds used to fund a loan, based on the specific institution's funding practices. In this model, risks associated with rates fluctuations are inherited from FHLB curve. Thus, cost of funds is:

$$Cost of Funds = Funded Amount \times ( Bank Funds Fraction \times Bank COF + Borrowed Funds Fraction \times Borrowed COF )$$

Cost of reserves is calculated as follows:

Cost of Reservers=Funded Amount×FAS5

FAS5 (also known as ALLL Rate) is equal to the ratio of allowance for possible loan and lease losses to total loans and lease-financing receivables not held for sale. FAS5 value is taken from UBPR report.

The overall loan cost for the bank includes an adjustment that has to be made based on the risk associated with the loan. This risk can be quantified as a “cost of risk adjustment” which is calculated as:

Cost of Risk Adjustment=Funded Amount×Risk Adjustment

In the above calculation, risk rating adjustment is based on the loan's risk rating code. See. e.g., FIG. 3 “Risk Rating Code: 34.” The risk rating code is identified and is determined as follows:

Risk Rating 31 (low risk): Adjustment=−0.1% (if FAS5>0.1%)
0% (IF FAS5≦0.1%)

Risk Rating 34 (medium risk): Adjustment=0%

Risk Rating 37 (high risk): Adjustment=0.1%

Thus, the margin is calculated by simply subtracting total cost from received revenue:

Total Margin=(Total Interest+Fee)−(Cost of Funds+Cost of Reserves+Cost of Risk Adjustment)

Taking into account the risk adjustment via the risk code, the cost of funds, and the cost of reserves, and cost of risk adjustment, for fixed loans, in view of the data sets noted in FIG. 2, the loan evaluation and the recommendation engine 212 can make recommendations for both the bank and the user.

The system and method of the present invention also provides analysis and recommendations for floating loans: that is, loans with a floating rate. Loans with a floating rate are also considered to be funded from two sources: bank funds and borrowed funds. With floating loans, the bank COF is calculated the same way as for fixed-rate loans. Borrowed COF is calculated based on an assumption of rolling funding. For purposes of the recommendation engine 212, it is assumed that a bank borrows funds for one year and then refinances the loan every year. Thus, 1-year FHLB rates are used during the whole life of the loan. Borrowed COF funds calculated this way does not include risk of rate fluctuations. Instead, this risk is accounted by calculating mars in as a sum for each month during the loan life:

$$Total Borrowed Funds Cost = ( Rate - Cost of Funds ) \times {\sum }_{i = 1}^{N} Outstanding {Balance}_{i}$$

The recommendation engine 212 assumes that if the borrowing rate changes, then the floating rate base index will change equally. Thus, the recommendation engine 212 assumes that there is a fixed margin through the loan life.

As discussed above, each category of loan is figured based on a loan purpose, as illustrated in FIG. 4 where the system inquires whether the purpose of the loan is for Land, Improved Real Estate, All Other, or Boats.” As part of the bank profile settings 206, equity rates associated with each category can be adjusted indirectly using the system's settings. Equity rates for equity categories 1 and 2 may be penalized based on the ratio of capital in CRE and related ventures and bank equity. Equity rates for category 1 change linearly from 100% down to tier one leverage ratio (“T1LR”) (but not less than 5%) based on the bank's CRE ratio compared to its peers. If the bank is currently in P percentile, then the equity rate for category 1 will be:

$$( 100 - T 1 LR ) \times \frac{P}{100}$$

Category 2 equity rates amount to half of category 1 rates, but no less than 5%. The equity rate for categories 3 and 4 are equal to the bank's tier one leverage ratio, but are no less than 5%.

Based on its strategy, via the bank's profile settings 206, a bank can specify that category 1 and 2 loans are not penalized with a high equity rate. In this case category 1 and 2 rates are equal to tier one leverage ratio, but are no less than 5%.

Similarly, the bank may adjust the settings to take into account the import of a Small Business Loan. If the evaluated loan is an SBA loan, then RAROE is calculated based on 25% of the loan amount. Also, a collected SBA premium is added to total margin. SBA premium is calculated as:

SBA Premium=10%×(Loan Amount×75%)

Rather than a “purpose code.” SBA loans being evaluated using the method and system of the present invention use an SBA Loan class code to determine the loan's purpose.

A system and method of dynamically and rapidly assessing customer acquisition probability and risk-adjusted return-on-equity concerning one or more potential loans is described above. Various details of the invention may be changed without departing from the scope of the invention. Furthermore, the foregoing description of the preferred embodiment of the invention and best mode for practicing the invention are provided for the purpose of illustration only and not for the purpose of limitation.

What is claimed is:

1. A computer implemented method of processing a loan request comprising the steps of:
a. providing computing device associated with a bank;
b. loading the bank computing device with a loan evaluation computer code, the loan evaluation computer code comprising:
i. an interface for accepting a loan request containing loan data,
ii. a loan evaluation model, and
iii. a recommendation engine;
c. receiving by the bank computing device, a loan request containing loan data;
d. receiving by the bank computing device, public bank data and private bank data;
e. evaluating by the bank computing device, the loan request;
f. displaying by the bank computing device, an output representing profitability of the loan request; and
g. generating by the bank computing device, user recommendations.

2. The method of claim 1 further comprising the step of generating by the bank computing device, bank recommendations based on the loan data, the public bank data, and the private bank data.

3. They method of claim 1, wherein the public bank data comprises bank performance data and market data.

4. The method of claim 3, wherein the public bank data comprises UBPR or call reports.

5. The method of claim 4, wherein the private bank data comprises the bank profile settings.

6. The method of claim 5 further comprising the step of configuring the bank profile settings by selecting one or more settings from the group consisting of: penalizing a CRE loan, penalizing a high-risk loan, setting a minimum rate, setting a maximum loan life, and utilizing a combined funds model.

7. The method of claim 6, wherein the private bank data comprises bank historical loan data.

8. The method of claim 2, wherein the bank recommendations comprise: risk-adjusted return-on-equity suggestions, bank profile settings changes, or user efficiency suggestions.

9. The method of claim 1, wherein the loan data comprises: a loan amount, a loan rate, a loan fee, a maturity period, an amortization period, an interest only period, a loan purpose code, an amount of noninterest bearing deposits, and a loan risk code.

10. The method of claim 1 further comprising the step of updating the public bank data and the private bank data daily, weekly, monthly, or quarterly.

11. The method of claim 1, wherein:
a. the loan evaluation computer code further comprises a bank dashboard; and
b. the method further comprises the step of reporting to the bank via the bank dashboard aggregate customer acquisition statistics and aggregate risk-adjusted return-on-equity.

12. An out-of-the-box computer implemented method of processing a loan request comprising the steps of:
a. providing computing device associated with a bank;
b. loading the bank computing device with a loan evaluation computer code, the loan evaluation computer code comprising:
i. an interface for accepting a loan request containing loan data.
ii. preloaded bank profile settings,
iii. loan evaluation model, and
iv. a recommendation engine;
c. receiving by the bank computing device, a loan request containing loan data;
d. receiving by the bank computing device public bank data;
e. evaluating by the bank computing device, the loan request;
f. displaying by the bank computing device, an output representing profitability of the loan request; and
g. generating by the bank computing device, user recommendations

13. The method of claim 12 further comprising the step of generating by the bank computing device, bank recommendations based on the loan data, the public bank data, and the preloaded bank profile settings.

14. The method of claim 13, wherein the bank recommendations comprise: risk-adjusted return-on-equity suggestions; bank profile settings changes; and/or user efficiency suggestions.

15. The method of claim 12, wherein the public bank data comprises bank performance data and market data.

16. The method of claim 15, wherein the public bank data comprises UBPR or call reports.

17. The method of claim 12 further comprising the step of configuring the preloaded bank profile settings by the bank by selecting one or more settings from the group consisting of: penalizing a CRE loan, penalizing a high-risk loan, setting a minimum rate, setting a maximum loan life, and utilizing a combined funds model.

18. The method of claim 12 further comprising the step of updating the public bank data daily, weekly, monthly, or quarterly.

19. A computer implemented method of processing a loan request comprising the steps of:
a. providing computing device associated with a bank;
b. loading the bank computing device with a loan evaluation computer code, the loan evaluation computer code comprising:
i. an interface for accepting a loan request containing loan data,
ii. an interface for accepting public bank data,
iii. an interface for accepting private bank data,
iv. a loan evaluation model, and
v. a recommendation engine;
c. receiving by the bank computing device, a loan request containing loan data, the loan data comprising loan amount, a loan rate, a loan fee, a maturity period, an amortization period, an interest only period, a loan purpose code, and an amount of noninterest bearing deposits;
d. receiving by the bank computing device, public bank data comprising market data, a UBPR report, and a call report;
e. receiving by the bank computing device, private bank data comprising bank historical data and bank profile settings;
f. evaluating by the bank computing device, the loan request using the loan data, the public bank data, and the private bank data
g. displaying by the bank computing device, a risk-adjusted return-on equity and a customer acquisition probability;
h. generating by the bank computing device, user recommendations based on the loan data, the public bank data, and the private bank data, the user recommendations comprising risk-adjusted return-on-equity suggestions; and
i. generating by the bank computing device, bank recommendations based on the loan data, the public bank data, and the private bank data, the bank recommendations comprising bank profile settings changes or user efficiency suggestions.

20. The method of claim 19 further comprising the step of updating the public bank data and the private bank data daily, weekly, monthly, or quarterly.
